(19) United States
(12) Patent Application Publication
(10) Pub. No.: US 2019/0001502 A1
(43) Pub. Date: Jan. 3, 2019

(54) ROBOT CONTROL DEVICE AND ROBOT SYSTEM

(71) Applicant: Seiko Epson Corporation, Tokyo (JP)

(72) Inventors: Takanobu MATSUMOTO, Minowa (JP); Hidetoshi SAITO, Fujimi (JP)

(21) Appl. No.: 16/021,238

(22) Filed: Jun. 28, 2018

(30) Foreign Application Priority Data
Jun. 29, 2017 (JP) 2017-127388

(51) Int. Cl. B25J 13/08; B25J 9/16

(52) U.S. Cl. CPC B25J 13/085; G05B 2219/37357; B25J 9/1633

(57) ABSTRACT

A robot control device controls a robot provided with a force detection device. The robot control device includes an extension slot having a connector to which an interface board to communicate with the force detection device can be connected. It is preferable that the extension slot is removable. It is also preferable that the robot control device has the interface board having a connector to be connected to the extension slot.

### BACKGROUND

### 1. Technical Field

The present invention relates to a robot control device and a robot system.

### 2. Related Art

A robot having a robot arm is known. The robot arm is made up of a plurality of arms connected via joint parts. On the arm on the most distal side, for example, a hand is attached as an end effector. Between the arm on the most distal side and the end effector, a force sensor (force detection device) is attached which detects a force applied to the hand. Each of the joint parts is driven by a motor. The driving of the joint part causes the arm to rotate. The robot, for example, grips a target object with the hand, moves the target object to a predetermined place, and carries out predetermined work such as assembling. Such a robot is controlled by a robot control device electrically connected to the robot via a cable or the like.

Also, for example, JP-A-8-323671 discloses a robot system including a robot, a force sensor provided in the robot, a robot controller which controls the driving of the robot, and a force sensitive controller (connection unit). The force sensitive controller is a connection unit serving as a relay between the force sensor and the robot controller, to connect the force sensor to the robot controller for use. The force sensitive controller finds the magnitude and direction of a force applied to the hand, based on a signal outputted from the force sensor, and outputs the results to the robot controller.

In the robot system described in JP-A-8-323671, the connection unit needs to be provided outside the robot controller to connect the force sensor to the robot controller for use. Therefore, a large space is needed to arrange the connection unit and the cable necessary for the connection of the connection unit. Also, the cable to connect the connection unit needs to be stretched around. This requires noise prevention measures.

### SUMMARY

An advantage of some aspects of the invention is to solve at least a part of the problems described above, and the invention can be implemented as the following application examples or forms.

A robot control device according to an aspect of the invention controls a robot provided with a force detection device. The robot control device includes an extension spot having a connector to which an interface board to communicate with the force detection device can be connected.

With such a robot control device, the interface board can be connected without using a cable or the like. This can reduce the space needed to install the robot and the robot control device. Also, since there is no need to use a cable or the like to connect the interface board, no noise prevention measures are needed.

In the robot control device according to the aspect of the invention, it is preferable that the extension slot is removable.

This makes it possible to provide the extension slot only when necessary.

It is preferable that the robot control device according to the aspect of the invention includes the interface board having a connector to be connected to the extension slot.

This enables the force detection device and the robot control device to communicate with each other.

In the robot control device according to the aspect of the invention, it is preferable that the interface board has a power supply which generates electric power to be supplied to the force detection device, from electric power supplied to the robot control device.

Thus, electric power can be supplied to the force detection device without having to provide a separate power supply for the force detection device.

In the robot control device according to the aspect of the invention, it is preferable that the interface board carries out a part of processing to be carried out by the force detection device.

This can reduce the number of circuit components of the force detection device and thus can miniaturize the force detection device.

In the robot control device according to the aspect of the invention, it is preferable that the interface board has a plurality of switches changing an address setting.

This enables the robot control device to communicate with the force detection device and other devices than the force detection device.

In the robot control device according to the aspect of the invention, it is preferable that the interface board has a plurality of connectors.

This enables another device as well as the force detection device to be connected to the interface board.

In the robot control device according to the aspect of the invention, it is preferable that the extension slot has a plurality of connectors.

This enables another interface board or the like to be connected to the extension slot.

In the robot control device according to the aspect of the invention, it is preferable that the force detection device has a processor which computes.

Thus, the force detection device with the computing unit can calculate and output a force applied to the robot.

A robot system according to another aspect of the invention includes a robot provided with a force detection device, and the robot control device according to the aspect for controlling the robot.

With such a robot system, the interface board can be connected without using a cable or the like. This can reduce the space needed to install the robot system. Also, since there is no need to use a cable or the like to connect the interface board, no noise prevention measures are needed.

### BRIEF DESCRIPTION OF THE DRAWINGS

The invention will be described with reference to the accompanying drawings, wherein like numbers reference like elements.

FIG. 1 is a perspective view (including a block diagram) showing a robot according to a first embodiment of a robot system according to the invention.

FIG. 2 is a front view of a robot control device of the robot system shown in FIG. 1.

FIG. 3 is a front view of the robot control device of the robot system shown in FIG. 1.

FIG. 4 shows an extension slot and an interface board of the robot system shown in FIG. 1.

FIG. 5 is a perspective view showing the interface board of the robot system shown in FIG. 1.

FIG. 6 is a block diagram showing a part of a force detection device and the interface board of the robot system shown in FIG. 1.

FIG. 7 is a block diagram showing a part of a force detection device and an interface board in a second embodiment of the robot system according to the invention.

### DESCRIPTION OF EXEMPLARY EMBODIMENTS

Hereinafter, a robot control device and a robot system according to the invention will be described in detail, based on embodiments shown in the accompanying drawings.

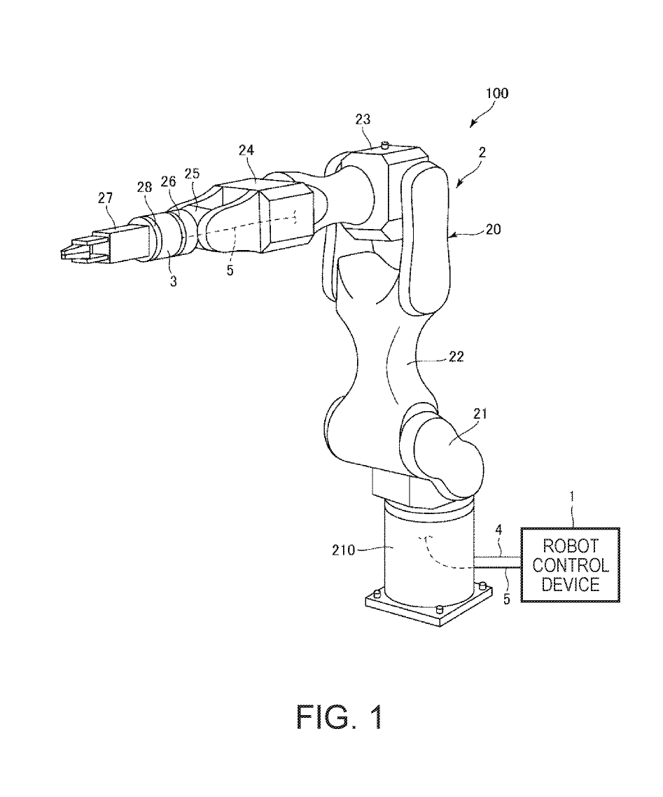

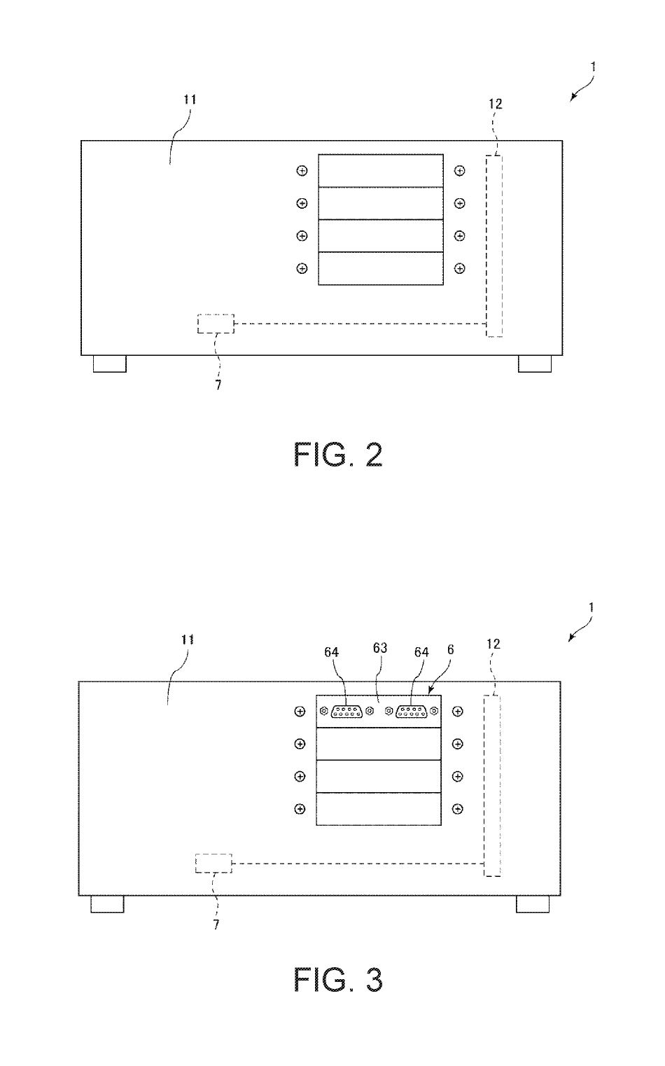

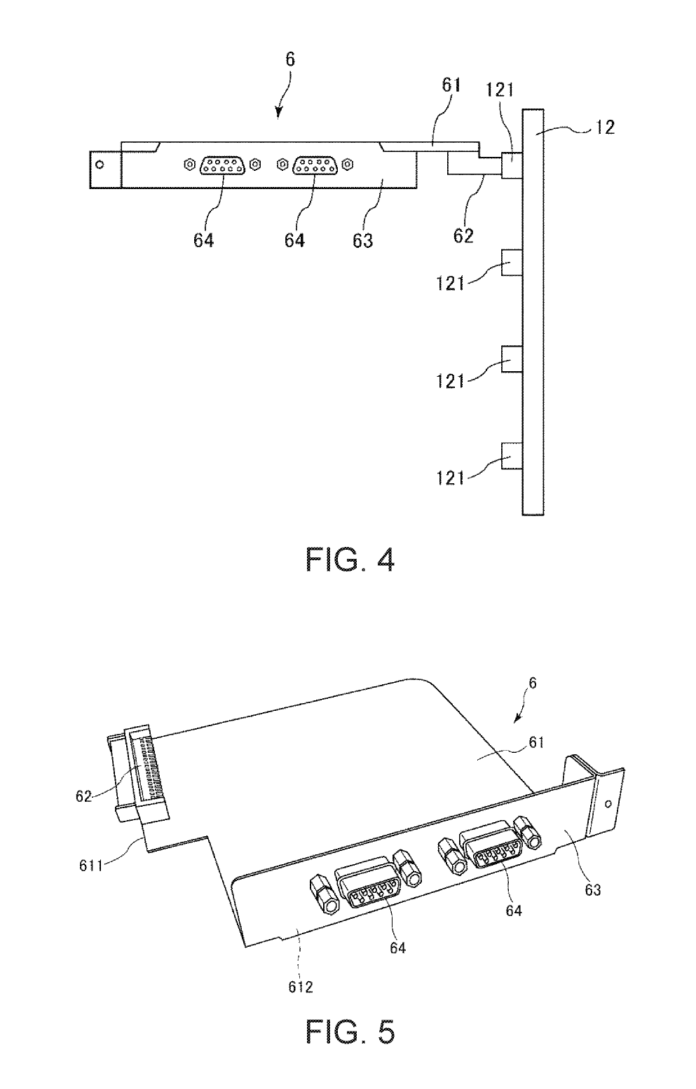

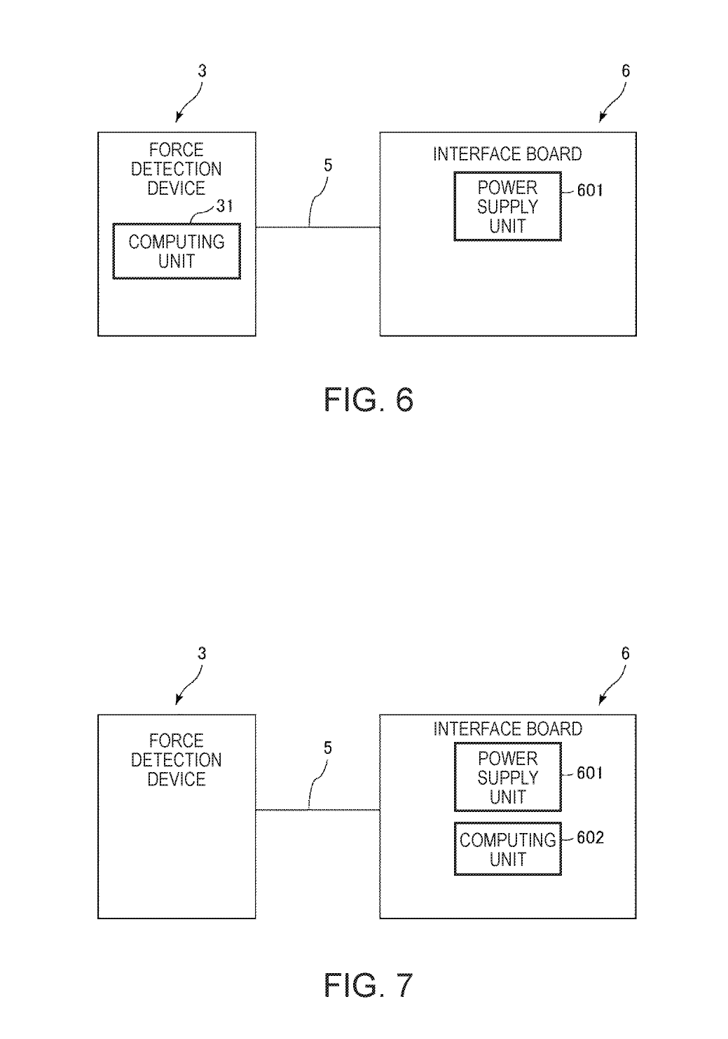

FIG. 1 is a perspective view (including a block diagram) showing a robot according to a first embodiment of a robot system according to the invention. FIGS. 2 and 3 are front views of a robot control device of the robot system shown in FIG. 1. FIG. 4 shows an extension slot and an interface board of the robot system shown in FIG. 1. FIG. 5 is a perspective view showing the interface board of the robot system shown in FIG. 1. FIG. 6 is a block diagram showing a part of a force detection device and the interface board of the robot system shown in FIG. 1. In FIGS. 2 and 3, a part of the illustration is omitted. In FIG. 5, the illustration of circuit components is omitted.

For the sake of convenience, the base 210 side in FIG. 1 is referred to as “proximal end” and the opposite side (end effector 27 side) is referred to as “distal end”.

A robot system 100 shown in FIG. 1 can be used, for example, for work such as holding, carrying, assembling and inspecting a workpiece (target object) such as an electronic component or electronic device. The robot system. 100 includes a robot control device 1 and a robot 2.

The robot 2 and the robot control device 1 are electrically connected (hereinafter also referred to simply as “connected”) via a cable 4.

The robot 2 and the robot control device 1 are not limited to wired connection and may, for example, communicate wirelessly with each other without having the cable 4. Also, a part or the entirety of the robot control device 1 may be built in the robot 2.

### Robot

The type of the robot 2 is not particularly limited. However, in this embodiment, the robot 2 is a vertically articulated robot.

As shown in FIG. 1, the robot 2 has a base 210 and a robot arm 20 connected rotatably to the base 210. To the robot arm 20, a force detection device 3 is removably connected. To the force detection device 3, an end effector 27 (member to be attached) is removably connected via an attachment member 28. The force detection device 3 may be provided in an unremovable manner. The end effector 27 may be provided in an unremovable manner.

The base 210 is, for example, a part fixed to a floor, wall, ceiling, or movable platform truck or the like. However, the base 210 may be movable.

The robot arm 20 includes an arm 21 (first arm), an arm 22 (second arm), an arm 23 (third arm), an arm 24 (fourth arm), an arm 25 (fifth arm), and an arm 26 (sixth arm). These arms 21 to 26 are connected in this order from the proximal end side toward the distal end side. Each of the arms 21 to 26 is rotatable in relation to the neighboring arm or the base 210.

The force detection device 3 is provided between the arm 26 situated at a distal end part (most distal end) of the robot arm 20 and the end effector 27. The force detection device 3 is connected directly to the arm 26 and is connected to the end effector 27 via the attachment member 28. Also, the force detection device 3 may be connected to the arm 26 via an attachment member (not illustrated). The force detection device 3 may be connected directly to the end effector 27.

The force detection device 3 detects a force (including a moment) applied to the end effector 27. Although not particularly limited, the force detection device 3 is made up of, for example, a 6-axis force sensor. As a specific example, the force detection device 3 has: a plurality of (for example, four) sensor devices each having a piezoelectric element (charge output element); an analog circuit board having a conversion output unit which converts the charge outputted form each sensor device to voltage; and a digital circuit board having an A/D converter which converts an analog signal to a digital signal and a computing unit (processor) 31 (see FIG. 6) which calculates a force in a predetermined direction, based on the voltage outputted from the conversion output unit. The computing unit 31 carries out various computations.

To the force detection device 3, one end part of a cable 5 (see FIGS. 1 and 6) is also connected. The cable 5 has a signal line and a power line and is arranged inside the robot 2. The one end part of the cable 5 may be connected to the force detection device 3, for example, in an unremovable manner. Also, a connection unit (connector) (not illustrated) may be provided at the one end part of the cable 5, and this connection unit may be removably connected to a connection unit (connector) (not illustrated) provided in the force detection device 3. Moreover, at the other end part of the cable 5, a connection unit (connector) (not illustrated) to be removably connected to a connection unit 64 of an interface board 6, described later, is provided. The cable 5 may also be arranged outside the robot 2.

The end effector 27 is an apparatus (device) which carries out work on a target object that is a target of work by the robot 2. The end effector 27 is made up of, for example, a hand having the function of gripping (holding) the target object. The end effector 27 may be any apparatus corresponding to the content of work by the robot 2. The end effector 27 is not limited to the hand and may be, for example, a screw tightening tool to tighten a screw.

The attachment member 28 is a member used to attach the end effector 27 to the force detection device 3. The attachment member 28 is a separate member from the end effector 27. However, the attachment member 28 is not limited to this example and may be integrated with the end effector 27.

Although not illustrated, the robot 2 has a drive unit having a motor or the like which rotates one arm in relation to another arm (or the base 210). The drive unit may or may not have a decelerator. The robot 2 also has an angle sensor (position sensor) which detects the angle of rotation of the axis of rotation of the motor or the axis of rotation of the decelerator, though not illustrated. The drive unit and the angle sensor are provided, for example, at predetermined sites of the base 210 and the arms 21 to 26, though not illustrated.

### Robot Control Device

The robot control device 1 has a control unit 7 which performs various kinds of control, and a storage unit or the like (not illustrated) which stores various kinds of information. The robot control device 1 can be made up of, for example, a PC (personal computer) with a built-in CPU (central processing unit) (not illustrated) and can control each part such as each drive unit of the robot 2. A program to control the robot 2 is stored in advance in the storage unit.

As shown in FIGS. 2 to 4, the robot control device 1 has a casing 11, an extension slot 12 as an example of an extension connection unit provided inside the casing 11, and an interface board 6 removably connected to the extension slot 12. FIG. 2 shows the robot control device 1 with the interface board 6 not provided thereon. FIG. 3 shows the robot control device 1 with the interface board 6 provided thereon.

In this embodiment, the extension slot 12 is removably provided inside the casing 11 and is connected to the control unit 7 or the like of the robot control device 1. This makes it possible to provide the extension slot 12 only when necessary. The extension slot 12 may be provided in an unremovable manner.

The extension slot 12 has a plurality of (in this embodiment, four) connection units 121 (connectors). These connection units 121 are arranged at equal spacings in a predetermined direction (vertical direction in FIG. 4). To each of the connection unit 121, a connection unit (connector) (in the case of the interface board 6, a connection unit 62) of a connection target object such as the interface board 6 can be removably connected. In this embodiment, the connection unit 62 of the interface board 6 is removably connected to one of the four connection units 121. To the other connection units 121, other connection target objects such as other interface boards can be removably connected. Meanwhile, the target objects to be connected to the other interface boards (connection target objects) are not particularly limited. For example, various measuring devices such as distance measuring device (distance sensor), image pickup device, peripheral processing device, PLC (programmable logic controller) and the like can be employed.

The spacings between the connection units 121 may not be equal. The number of the connection units 121 is not limited to four and may be two, three, or five or more. The number of the connection unit 121 may be one, instead of plural.

### Interface Board

The interface board 6 has the function of communicating with the force detection device 3, that is, the function of connecting the force detection device 3 and the robot control device 1 in such a way as to be able to communicate.

As shown in FIGS. 4 and 5, the interface board 6 includes a circuit board 61 having a circuit made up of a circuit element (circuit component), not illustrated, and a wiring or the like, a connection unit 62 (connector) provided on the circuit board 61, and an attachment plate 63 provided on the circuit board 61. The attachment plate 63 is provided with a plurality of (in this embodiment, two) connection units 64 (connectors).

The shape of the circuit board 61 is not particularly limited. However, in this embodiment, the circuit board 61 has a quadrilateral shape with one corner removed (missing), as viewed in a plan view of the circuit board 61, as shown in FIG. 5.

The connection unit 62 is provided on one side 611 of the circuit board 61. The attachment plate 63 is provided on a side 612 where the connection unit 62 is not provided, of the circuit board 61. The side 612 is different from the side 611 where the connection unit 62 is provided and the side opposite the side 611, of the circuit board 61. Therefore, the direction in which the connection unit 62 protrudes and the direction in which the connection units 64 protrude are different from each other by a predetermined angle (in this embodiment, 90 degrees).

Arranging the connection units 62, 64 in this way allows the direction of connection of the connection unit 62 and the direction of connection of the connection units 64 to differ from each other.

With this interface board 6, when a plurality of interface boards (not illustrated) having the connection units 62, 64 arranged similarly to those of the interface board 6 are connected to the extension slot 12, all of the connection units 64 can be laid in the same direction.

The positions where the connection unit 62 and the attachment plate 63 are arranged may be different from the foregoing positions.

The connection unit 62 of the interface board 6 is removably connected to the connection unit 121 of the extension slot 12. The interface board 6 is removably attached to the casing 11, for example, with a screw or the like (see FIG. 3). In the state where the connection unit 62 of the interface board 6 is connected to the connection unit 121 of the extension slot 12 and where the interface board 6 is attached to the casing 11, each connection unit 64 is exposed outside from the casing 11 (see FIG. 3).

To each connection unit 64, for example, a connection unit (connector) of a connection target object such as the force detection device 3 can be removably connected. In this embodiment, a connection unit (not illustrated) provided at an end part of the cable 5 connected to the force detection device 3 is removably connected to one of the two connection units 64.

The connection target object to be connected to the other one of the two connection units 64 is not particularly limited. For example, various measuring devices such as distance measuring device (distance sensor), image pickup device, peripheral processing device, PLC (programmable logic controller) and the like can be employed. If, for example, a dual-arm robot is used as the robot in this case, two force detection devices provided on the two robot arms of the dual-arm robot can be connected to the two connection units 64. Also, for example, a force detection device can be provided at a distal end part (between the arm 26 and the end effector 27) of the robot arm 20 of the robot 2 and at a proximal end part (between the arm 21 and the base 210), and the two force detection devices can be connected to the two connection units 64.

The standard for communication between the interface board 6 and the force detection device 3 is not particularly limited. Parallel communication (for example, ISA (Industry Standard Architecture), ATA (Advanced Technology Attachment), SCSI (Small Computer System Interface), PCI (Peripheral Component Interconnect), front-side bus or the like), or serial communication (for example, RS-485, RS-422, RS-232, Ethernet, USB (Universal Serial Bus), optical communication or the like) can be employed.

The method for connection between the interface board 6 and a circuit subsequent to the interface board in the robot control device 1 is not particularly limited. However, in this embodiment, the interface board 6 and the circuit are connected via a bus. The standard for connection between the interface board 6 and the circuit subsequent to the interface board in the robot control device 1 is not particular limited. Parallel communication (for example, ISA (Industry Standard Architecture), ATA (Advanced Technology Attachment), SCSI (Small Computer System Interface), PCI (Peripheral Component Interconnect), front-side bus or the like), or serial communication (for example, RS-485, RS-422, RS-232, Ethernet, USB (Universal Serial Bus), optical communication or the like) can be employed.

The number of the connection units 64 is not limited to two and may be three or more. The number of the connection units 64 may be one instead of plural.

The interface board 6 also has the functions described below, in addition to the functions as a normal interface (communication function and the like).

### Function 1

As shown in FIG. 6, the interface board 6 has a power supply unit 601 (power supply) which generates electric power to be supplied to the force detection device 3, from electric power supplied to the robot control device 1, and supplies the generated electric power to the force detection device 3. A specific example will be described below.

Electric power (power-supply voltage) is supplied to the robot control device 1 from outside, changed to a predetermined power-supply voltage in the robot control device 1, and used by the robot control device 1. The predetermined power-supply voltage is inputted (applied) to the power supply unit 601 of the interface board 6 via the extension slot 12. The power supply unit 601 changes (in this embodiment, boosts) the predetermined power-supply voltage used in the robot control device 1 to a predetermined power-supply voltage to be used by the force detection device 3. The power-supply voltage to be used by the force detection device 3 is inputted to the force detection device 3 from the interface board 6 via the cable 5. Since the interface board 6 has the power supply unit 601 in this way, electric power can be supplied to the force detection device 3 without having to provide a separate power supply for the force detection device 3. This can reduce the space needed to install the robot system 100.

### Function 2

The interface board 6 has the function of changing the address setting in communication.

Specifically, the interface board 6 has a plurality of switches (not illustrated) to set an address. Turning a predetermined switch “ON”, of the plurality of switches, sets a predetermined address (for example, address “3”). Turning another predetermined switch “ON” sets another predetermined address (for example, address “7”). The address setting can thus be changed.

If the address for the robot control device 1 to communicate with the force detection device 3 is set, for example, to “3”, the switch of the interface board 6 sets the address to “3”. Meanwhile, if another interface board (not illustrated) is connected to another connection unit 121 of the extension slot 12, with a distance measuring device (not illustrated) connected to this interface board, and the address for the robot control device 1 to communicate with the distance measuring device is set, for example, “7”, the interface board sets the address to “7”.

Thus, if the address indicated by a signal traveling through the address line is “3”, the robot control device 1 communicates with the force detection device 3 via the interface board 6. If the address is “7”, the robot control device 1 communicates with the distance measuring device via another interface board. In this way, the robot control device 1 can communicate with the force detection device 3 and the distance measuring device.

Next, an operation in the case of using the force detection device 3 of the robot system 100 will be described.

The robot control device 1 controls the driving (operation) of the robot 2 in the form of position control, force control, and the like in the work carried out by the robot 2, based on an output from each angle sensor and an output from the force detection device 3, that is, detection information (result of detection) by each angle sensor and detection information (result of detection) by the force detection device 3, or the like.

The position control is to control the operation of the robot 2 in such a way that the distal end part of the robot arm 20 of the robot 20 or the end effector 27 moves into a target position and a target attitude, based on information about the position and attitude of the distal end part of the robot arm 20 or the end effector 27. The information about the position and attitude of the distal end part of the robot arm 20 or the end effector 27 can be found based on the detection information by each angle sensor.

The force control is to control the operation of the robot 2 by detecting a force with the force detection device 3 and then changing the position and attitude of the distal end part of the robot arm 20 or the end effector 27 or pushing or pulling the end effector 27, based on the detection information by the force detection device 3. The force control includes, for example, impedance control or the like.

First, the force detection device 3 detects a force applied to the end effector 27. In this case, in the force detection device 3, each sensor device of the force detection device 3 outputs a charge, and the conversion output unit of the analog circuit board of the force detection device 3 converts the charges into voltage. The computing unit 31 on the digital circuit board of the force detection device 3 calculates (finds) a force in a predetermined direction, based on the voltage outputted from the conversion output unit, and outputs a signal indicating the force. The signal outputted from the force detection device 3 is transmitted to the robot control device 1. In this case, the signal outputted from the force detection device 3 is transmitted (inputted) to the interface board 6 of the robot control device 1 via the cable 5, then converted at the interface board 6 into a predetermined standard (format) usable in the robot control device 1, and inputted to the control unit 7 or the like via the extension slot 12. The detection information by the force detection device 3 inputted to the robot control device 1 is used to control the robot 2. As an example of the control on the robot 2 by the robot control device 1, the robot control device 1 controls the driving of the robot 2 in such a way that the force in the predetermined direction detected by the force detection device 3 becomes a target force.

As described above, in the robot system 100, the interface board 6 can be connected without using a cable or the like. This can reduce the space needed to install the robot system 100. Also, since there is no need to use a cable or the like to connect the interface board 6, no noise prevention measures are needed.

As described above, the robot control device 1 controls the robot 2 provided with the force detection device 3. The robot control device 1 includes the extension slot 12 (extension connection unit) having the connection unit 121, to which the interface board 6 to communicate with the force detection device 3 can be connected.

With such a robot control device 1, the interface board 6 can be connected without using a cable or the like. This can reduce the space needed to install the robot 2 and the robot control device 1. Also, since there is no need to use a cable or the like to connect the interface board 6, no noise prevention measures are needed.

The extension slot 12 (extension connection unit) is removable. This makes it possible to provide the extension slot 12 only when necessary.

The robot control device 1 includes the interface board 6 having the connection unit 62 to be connected to the extension slot 12 (extension connection unit). This enables the force detection device 3 and the robot control device 1 to communicate with each other.

The interface board 6 has the power supply unit 601, which generates electric power to be supplied to the force detection device 3, from electric power supplied to the robot control device 1. Thus, electric power can be supplied to the force detection device 3 without having to provide a separate power supply unit for the force detection device 3.

The interface board 6 has the function of changing the address setting. This enables the robot control device 1 to communicate with the force detection device 3 and other devices than the force detection device 3.

The interface board 6 has the plurality of connection units 64. This enables another device as well as the force detection device 3 to be connected to the interface board 6.

The extension slot 12 (extension connection unit) has the plurality of connection units 121. This enables another interface board or the like to be connected to the extension slot 12.

The force detection device 3 has the computing unit 31, which computes. Thus, the force detection device 3 with the computing unit 31 can calculate and output a force applied to the robot 2.

The robot system 100 includes the robot 2 provided with the force detection device 3, and the robot control device 1 for controlling the robot 2.

With such a robot system 100, the interface board 6 can be connected without using a cable or the like. This can reduce the space needed to install the robot system 100. Also, since there is no need to use a cable or the like to connect the interface board 6, no noise prevention measures are needed.

### Second Embodiment

FIG. 7 is a block diagram showing a part of a force detection device and an interface board in a second embodiment of the robot system according to the invention.

The second embodiment will now be described. Differences from the foregoing embodiment will be mainly described and similar matters will not be described further in detail.

In the robot system 100 according to the second embodiment, the interface board 6 has the function of carrying out a part of processing (computational processing) carried out by the force detection device 3 in the first embodiment.

Specifically, the interface board 6 has a computing unit 602 which computes, as shown in FIG. 7. The computing unit 602 has the function of the computing unit 31 of the force detection device 3 in the first embodiment. The computing unit 31 of the force detection device 3 is omitted. In this robot system 100, the computing unit 602 calculates a force in a predetermined direction, based on the voltage outputted from the convention output unit of the force detection device 3.

The computing unit 602 may have a part of the functions of the computing unit 31 of the force detection device 3, instead of the entire functions. That is, the force detection device 3 may have the computing unit 31, and the computing unit 31 and the computing unit 602 both carry out computation (complement each other). In a specific example of this, if, for example, a 6-axis force sensor is used as the force detection device 3, the computing unit 31 calculates a force in one or some axial directions, of forces in the six axial directions, and the computing unit 602 calculates a force in the remaining axial direction(s). In another specific example, to calculate a force in a predetermined direction, the computing unit 31 carries out computation up to a certain point, and the computing unit 602 carries out the remaining computation.

The second embodiment as described above can achieve effects similar to those of the foregoing embodiment.

In this robot system 100, the number of circuit components of the force detection device 3 can be reduced, thus miniaturizing the force detection device 3.

As described above, in the robot control device 1, the interface board 6 carries out a part of processing (computational processing) to be carried out by the force detection device 3. This can reduce the number of circuit components of the force detection device 3 and thus miniaturize the force detection device 3.

The robot control device and the robot system according to the invention have been described, based on the illustrated embodiments. However, the invention is not limited to these embodiments. The configuration of each part can be replaced with any configuration having similar functions. Any other component can be added as well.

The invention may be a combination of two or more arbitrary configurations (features) of the embodiments.

In the embodiments, the number of axes of rotation of the robot arm is six. However, in the invention, the number of axes of rotation of the robot arm is not limited to this example and may be, for example, two, three, four, five, or seven or more. That is, while the number of arms (links) in the embodiments is six, the number of arms in the invention is not limited to this example and may be, for example, two, three, four, five, or seven or more.

In the embodiments, the number of robot arms is one. However, the number of robot arms in the invention is not limited to this example and may be, for example, two or more. That is, the robot may be, for example, a multi-arm robot such as a dual-arm robot.

In the invention, the robot (robot main body) may be other types (forms) of robots. A specific example can be a horizontally articulated robot such as SCARA robot, or a legged walking (running) robot having legs.

The entire disclosure of Japanese Patent Application No. 2017-127388, filed Jun. 29, 2017 is expressly incorporated by reference herein.

What is claimed is:

1. A robot control device which controls a robot provided with a force detection device, the robot control device comprising:
an extension slot having a connector to which an interface board to communicate with the force detection device can be connected.

2. The robot control device according to claim 1, wherein the extension slot is removable.

3. The robot control device according to claim 1, comprising the interface board having a connector to be connected to the extension connection unit.

4. The robot control device according to claim 1, wherein the interface board has a power supply which generates electric power to be supplied to the force detection device, from electric power supplied to the robot control device.

5. The robot control device according to claim 1, wherein the interface board carries out a part of processing to be carried out by the force detection device.

6. The robot control device according to claim 1, wherein the interface board has a plurality of switches changing an address setting.

7. The robot control device according to claim 1, wherein the interface board has a plurality of connectors.

8. The robot control device according to claim 1, wherein the extension connection unit has a plurality of connectors.

9. The robot control device according to claim 1, wherein the force detection device has a processor which computes.

10. A robot system comprising:
a robot provided with a force detection device; and
the robot control device including an extension slot having a connector to which an interface board to communicate with the force detection device can be connected.

11. A robot system according to claim 10, wherein the extension slot is removable.

12. A robot system according to claim 10, comprising the interface board having a connector to be connected to the extension slot.

13. A robot system according to claim 10, wherein the interface board has a power supply which generates electric power to be supplied to the force detection device, from electric power supplied to the robot control device.

14. A robot system according to claim 10, wherein the interface board carries out a part of processing to be carried out by the force detection device.

15. A robot system according to claim 10, wherein the interface board has a plurality of switches changing an address setting.

16. A robot system according to claim 10, wherein the interface board has a plurality of connectors.

17. A robot system according to claim 10, wherein the extension connection unit has a plurality of connectors.

18. A robot system according to claim 10, wherein the force detection device has a processor which computes.
